(19) United States
(12) Patent Application Publication
(10) Pub. No.: US 2013/0289968 A1
(43) Pub. Date: Oct. 31, 2013

(54) STATEFUL SIMULATION

(71) Applicants: Jakub Vondrak, Prague (CZ); Jiri Sofka, Sedlcany (CZ); Jiri Tejkl, Novy Maun (CZ)

(72) Inventors: Jakub Vondrak, Prague (CZ); Jiri Sofka, Sedlcany (CZ); Jiri Tejkl, Novy Maun (CZ)

(21) Appl. No.: 13/456,800

(22) Filed: Apr. 26, 2012

(51) Int. Cl. G06F 9/45

(52) U.S. Cl. 703/22

(57) ABSTRACT

Systems, methods, and computer-readable and executable instructions are provided for generating a stateful simulation program. Generating a stateful simulation program can include arranging a number of recorded request-response pairs in a sequence order to generate a number of tracks. Generating a stateful simulation program can also include assigning a state to each of the number of request-response pairs and calculating a cost for each state based on a number of current requests. Furthermore, generating a stateful simulation program can include generating the stateful simulation program based on a selected state with a desired cost.

### BACKGROUND

A service oriented architecture (SOA) environment can consist of a mesh software of services. Each service can implement a number of actions. The services can be owned and operated by the same organization as well as multiple organizations. Some of the services can have restricted access and/or paid services.

### BRIEF DESCRIPTION OF THE DRAWINGS

FIG. 1 illustrates a flow chart of an example method for generating a stateful simulation program according to the present disclosure.

FIG. 2 illustrates a diagram of an example process for selecting a desired track for generating a stateful simulation program according to the present disclosure.

FIG. 3 illustrates a diagram of an example computing system that can be utilized for generating a stateful simulation program according to the present disclosure.

### DETAILED DESCRIPTION

Examples of the present disclosure include methods, systems, and computer-readable and executable instructions for generating a stateful simulation program. Methods for generating a stateful simulation program can include arranging a number of recorded request-response pairs in a sequence order to generate a number of tracks. Generating a stateful simulation program can also include assigning a state to each of the number of request-response pairs. Generating a stateful simulation program can also include calculating a cost for each state based on a number of current requests. Furthermore, generating a stateful simulation program can include generating the stateful simulation program based on a selected state with a desired cost.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

Within an SOA environment there can be a desire to perform a performance test on a composite application. The composite application can have a number of individual programs (e.g., services, etc.). The number of individual programs can be unavailable during a desired testing period. For example, the number of individual programs can be owned by a third party and access may not be granted for the performance test of the composite application. A number of virtual programs can be generated to replace the individual program (e.g., real services, real program). A number of individual programs can exhibit a stateful behavior (e.g., a stateful program) that can be replaced by a stateful simulation program that simulates the stateful behavior. The stateful simulation program as described herein can be accomplished without known transition probabilities between a number of states.

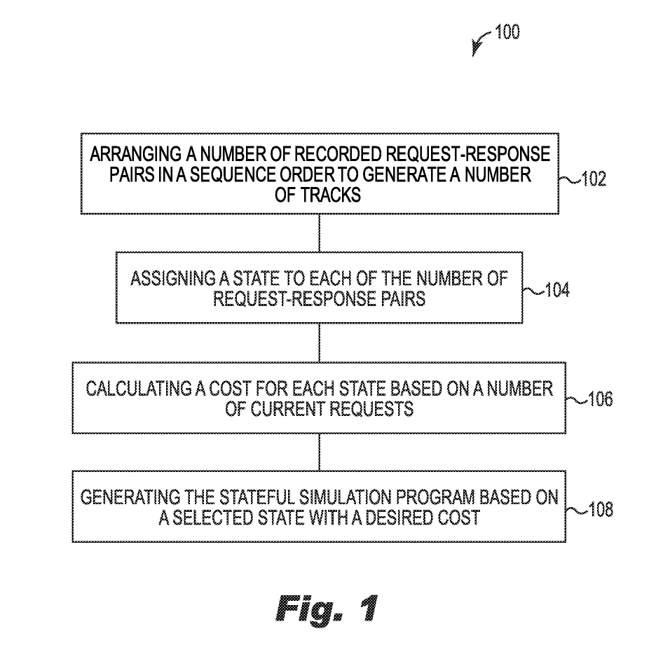

FIG. 1 illustrates a flow chart of an example method 100 for generating a stateful simulation program according to the present disclosure. The stateful simulation program can include a computer program that exhibits a stateful behavior. For example, the stateful behavior in one embodiment can mean that there are different responses returned for identical requests depending on a context of previous requests.

At 102, a number of recorded request-response pairs are arranged in a sequence order to generate a number of tracks. The number of request-response pairs can be recorded utilizing an application monitor. For example, a number of monitors can be utilized to record a user request and the corresponding application response.

The application can exhibit stateful behavior that can produce a different response for an identical request. For example, if there are a total of three requests, the first request A can have a first response X. A second request B can have a second response Y. A third request A can have a third response Z. In this example, the first request and the third request are identical (request A), however the first response X and the third response Z from the application are different.

A request-response pair can comprise a request by the user and the corresponding response from the application. In the above example, the first request A and the first response X can be a single request-response pair.

The sequence order can be the order that the request-response pairs are reported by the monitor. In the above example, the sequence order can be the order that the three requests-response pairs are reported by the monitor. For example, the first request A and the first response X can be considered a single request-response pair that is first in the sequence order. The second request B and the second response Y can be considered a single request-response pair that is second in the sequence order.

A stateful program can generate a different response for an identical request based on a context of previous requests. The context of the previous requests can be the sequence order of a number of previous requests. The sequence order can be utilized to determine the context of the previous requests.

The number of request-response pairs and the sequence order of the request-response pairs can be utilized to generate a number of tracks. The number of tracks can comprise the number of request-response pairs in a sequence order for a user. For example, for each user of an application a new track can be generated.

The user can be a real user and/or a virtual user that is starting a new session with the application. For example, a track can be generated for a user that includes a number of request-response pairs for a particular session with the application. The particular session can include a time period between when a user begins interaction with the application and when a user ends interaction with an application. For example, the particular session can include a number of request-response pairs for the time between the user logging into the application and the user logging off of the application.

The number of generated tracks are placed into a track order. The track order can be determined by the date the track was generated. For example, tracks can be arranged sequentially based on the date the track was generated. The sequentially arranged number of tracks can be placed in an order of priority, wherein the newer tracks are given a higher priority. For example, applications can change the response to particular requests, for this reason tracks that are created most recently can be more accurate to the actual responses of the real application.

At 104, a state is assigned to each of the number of request-response pairs. The assigned state can be an active state or an inactive state. In an example, all of the request-response pairs are assigned an inactive state except for starting points prior to any current requests.

An active state can be assigned to a starting point. The starting point can be a position that is prior to the first request-response pair in the sequence order. For example, if the first request-response pair is for a request A and a response X (e.g., request-response pair A-X) and a second request-response pair is for a request B and a response Y (e.g., request-response pair B-Y) the starting point can be a position before request-response pair A-X. In this example, the sequence order can be: Starting Point, request-response pair A-X, request-response pair B-Y. Before a number of current requests, the starting point can be assigned an active state and request-response pair A-X and B-Y can be assigned an inactive state.

An active state can be assigned to a request-response pair when the request from the request-response pair matches a current request. For example, if the current request is A, then a request-response pair with a request of A can be assigned an active state.

At 106, a cost is calculated for each state based on a current request and previous state. The cost can indicate how each state corresponds with received request(s). For example, a state that includes a request-response pair A-X (e.g., state A) can have a calculated cost of infinity if there are no current requests of A. In another example, the state A can have a calculated cost of less than infinity if there is a current request A. Furthermore, in another example, the state A can have a lowest cost compared to a number of states within a number of tracks.

As described herein, there can be a starting point that is assigned a state. The starting point can be an active state with a cost of zero. The starting point can have a calculated cost of zero.

A cost can be calculated for each state after each of the current requests. For example, prior to any current requests, the cost for each of the states within the track can be infinity except for starting points. In another example, after a current request A, the cost for each state containing request-response pair with A request can be calculated and can result in each state A having a cost of less than infinity and each state that is not state A having a cost of infinity. Furthermore, in the same example, one of the A states within the number of tracks can be a lowest cost state.

The lowest cost state can be calculated based on a number of factors. For example, the lowest cost state can be calculated based in part on the track order. As described herein, the track order can include a number of tracks organized sequentially by the most recently recorded track to the least recently recorded track. A more recently recorded track can have a lower starting point cost than a less recently recorded track. For example, if Track 1 is recorded at time X and Track 2 is recorded at time Y, the starting point for Track 1 can have a lower cost if time X is more recent than time Y.

The lowest cost state can be calculated based in part on a transition in the sequence order. The transition in the sequence order can include a jump and/or a skip in the sequence order. For example, if the request order is A, C, B, the sequence order for Track 1 is A, C, B, and the sequence order for Track 2 is A, D, B, then state B from Track 1 can be the lowest cost state. In the same example, state B from Track 1 and state B from Track 2 are in the same sequence order as state B of the request order; however, state D is transitioned in order to reach state B, since state D did not correspond to the request order. The transition in the sequence order can add additional cost to the state B in Track 2 and thus cannot be the lowest cost state.

The lowest cost state can further be calculated in part on a reverse transition switch in the sequence order. For example, if the request order is A, C, B, the sequence order for Track 1 is A, C, B, D and the sequence order for Track 2 is A, B, C, E, then state B from Track 1 can be the lowest cost state. When calculating the cost for Track 2 a comparison can be made between the request order (A, C, B) and the sequence order for Track 2 (A, B, C). In this example, state A from Track 2 corresponds to state A in the request order. In the same example, the second request in the request order is state C and in Track 2 state B is transitioned in order to reach state C. When state B is transitioned there is an extra cost associated with the transition as described herein. The third request in the request order is B, and in order to match state B from Track 2, a reverse transition may be performed. In this example, a starting point can be represented prior to state A, and a first direction can be set: Starting Point, A, B, C

The lowest cost state can also be calculated based in part on a previous cost of a state. For example, if Track 1 comprises a starting point, A, B, A, with a first current request A, then each state A within Track 1 can be an active state with a cost associated with each state A. For example, each state A in Track 1 can have a previous cost of infinity. In this example, the starting point can have a previous cost of 0 plus an aging cost of 0.1, resulting in a cost of 0.1. In the same example, state A closest to the starting point can be calculated based on a cost of starting point (spawning source) with the cost of 0 and no additional cost for transitions and/or reverse transitions, resulting in a cost of 0. In the same example, state A farthest away from the starting point can be calculated based on a cost of starting point (spawning source) with the cost of 0 plus an additional cost 0.2 for a transition of state A and a transition of state B (e.g., when each transition is given a value of 0.1). Therefore, state A closest to the starting point can have a lowest cost and the response associated with state A can be utilized to respond to the current request A.

In the above example, if there is a second current request B, the previous cost for each of the active states can be utilized to calculate a lowest cost state B. For example, if the previous costs associated with Track 1 are starting point 0.1), A (0), B (infinity), A (0.2), then the previous cost of each active state can be a starting cost for calculating the cost after the second current request B. For example, the second current request B can make each state B within Track 1 an active state. Only a current active state can spawn a new active state. For example, the starting point for the first current request A was the only active state and therefore the cost of spawning a new active state A was calculated from the starting point. The second current request B has active states comprising the starting point, state A closest to the starting point, and state A farthest from the starting point.

When calculating the cost of state B in Track 1 the previous cost of the starting point (0.1), state A closest to the starting point (0), and state A farthest from the starting point (0.2) can be utilized. For example, from the starting point with a previous cost (0.1), there can be an additional cost (0.1) added to state B for a transition of state A to reach state B. Thus, starting from the starting point can result in the previous cost of 0.1 and an additional cost for a transition of 0.1 and resulting in a total cost of 0.2.

In another example for calculating the cost of state B in Track 1 the previous cost of state A closest to the starting point can be 0 with no additional cost for a transition, and resulting in a cost of 0 for state B.

Furthermore, in another example for calculating the cost of state B in Track 1 the previous cost of state A farthest from the starting point can be 0.2 with an additional cost for a change in direction of 0.1 and resulting in a total cost of 0.3 for state B.

In the above example, the lowest cost for state B in Track 1 would be b 0 from the example of spawning the active state B from state A closest to the starting point. In this example, each state used for spawning in response to the second current request B would have an additional aging cost. For example, the starting point can add an additional cost of 0.1 to the previous cost of the starting point 0.1 and resulting in a cost of 0.2. In the same example, after the second current request B, the cost for each state within Track 1 can include adding an aging cost of 0.1 to the previous cost after the first current request A and can result with the following cost: the starting point (0.2), state A (0.1), state B (0), state A (0.3).

For each current request a state with the lowest cost can be determined. The state with the lowest cost, which can also match the current request, can be utilized to provide a response associated with the state to the current request. After the second current request B in the above example, the lowest cost state can be state B. In this example, the response associated with state B can be utilized to respond to the second current request B.

At 108, the stateful simulation program is generated based on a selected state with a desired cost. The desired cost can be the lowest cost state as described herein. The response associated with the lowest cost state can utilized to as the response to a current request.

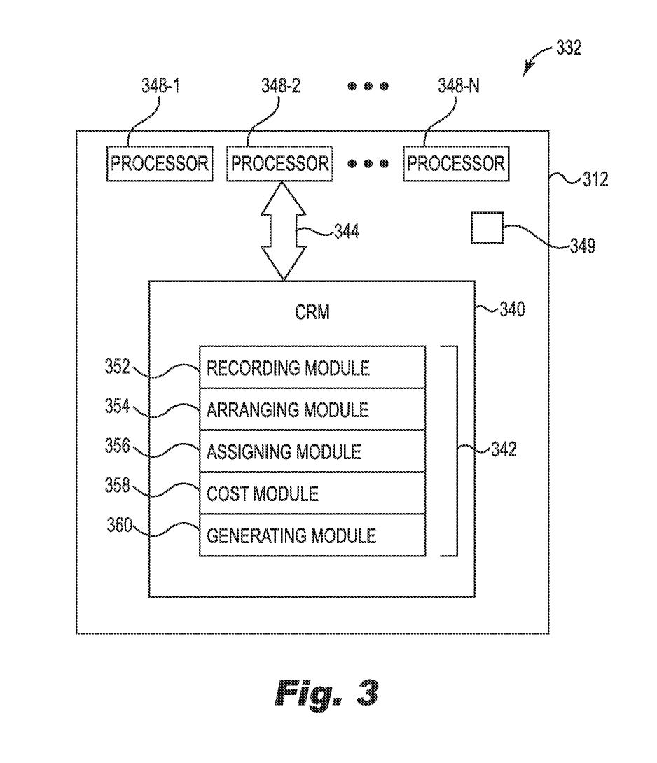

A number of states can be saved and/or remembered by a computing system (e.g., computing system 332 as described in FIG. 3) with a computer readable memory (e.g., CRM 340 as described in FIG. 3). The number of states to be saved can be a desired number of states with a desired cost. For example, the number of states to be saved can be a number of states with a lowest cost compared to a total number of states within a track.

A total of three states can be saved for each current request. The total of three states can include a lowest cost state and two other states that have a low cost compared to a number of states within a track. For example, at a particular current request, the starting point can have a cost of 0.2 from a first aging cost and a second aging cost, state A can have a cost of 0.1 from a first aging cost, and state B can have a cost of 0. A number of remaining states C, D, and E within a track can have a cost of infinity (e.g., non-active states). Therefore, in this example, the starting point, state A, and state B from the track can be saved for the particular current request and the remaining states C, D, and E within the track may not be saved to memory.

The number of states to be saved to memory can be altered to a desired number of states to be saved. For example, the number of states to be saved to memory can be increased to increase a robustness of the stateful simulation. The robustness can include an ability of the stateful simulation to continue to operate despite abnormalities in the number of current requests. In another example, the number of states to be saved to memory can be decreased to decrease a memory footprint and increase a computing performance. The memory footprint can be an amount of memory that the stateful simulation program utilizes or references while in operation.

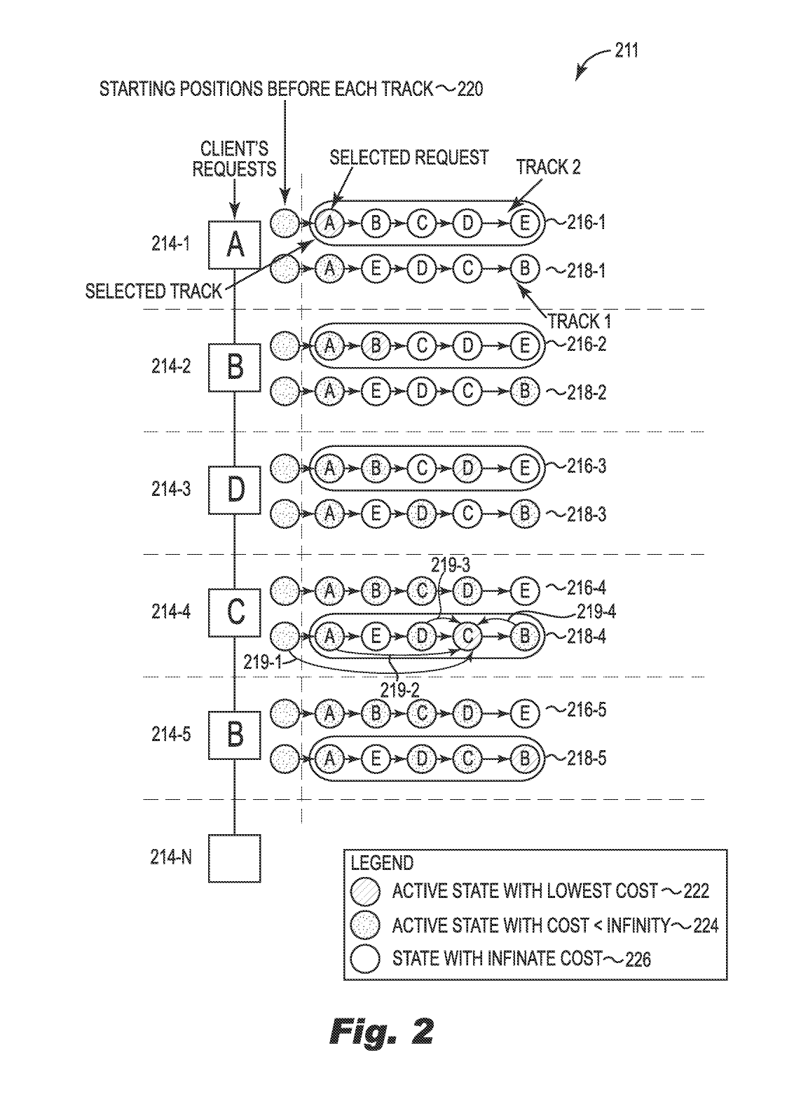

FIG. 2 illustrates a diagram 211 of an example process for selecting a desired track for generating a stateful simulation program according to the present disclosure.

As described herein, a number of request-response pairs can be assigned a state and arranged in a sequence order. In FIG. 2, a number of request-response pairs are represented by a number of states labeled A, B, C, D, and E and arranged in a sequence order forming two tracks 216-1 and 218-1. Tracks 216-1, 216-2, 216-3, 216-4, 216-5 represent a single track that has an earliest recorded time for a total number of tracks. Tracks 218-1, 218-2, 218-3, 218-4, 218-5 represent a single track that has a later recorder time than tracks 216-1, 216-2, 216-3, 216-4, 216-5.

Tracks 216-1, 216-2, 216-3, 216-4, 216-5 represent Track 2 and a resulting number of assigned states and calculated costs after a number of current requests (e.g., a number of clients' requests) 214-1, 214-2, 214-3, 214-4, 214-5. Tracks 218-1, 218-2, 218-3, 218-4, 218-5 represent Track 1 and a resulting number of assigned states and calculated costs after a number of current requests 214-1, 214-2, 214-3, 214-4, 214-5.

The selected track for each of the number of current requests 214-1, 214-2, 214-3, 214-4, 214-5 is represented by a circled track. For example, after current request A 214-1, the selected track with the lowest cost state is track 2 216-1.

Each track 216-1-216-5, 218-1-218-5 is assigned a starting point (e.g., starting position) 220. The starting point can be assigned an active state and can have a cost of zero before the number of current requests.

Current request A 214-1 is received and is the first request in the request order. With current request A 214-1, the state A from Track 1 218-1 and the state A from Track 2 216-1 are assigned an active state. These new active states are spawned from the starting points. State A from Track 1 218-1 and state A from Track 2 216-1 are both in a first position and both directly correspond to the current request A 214-1. As described herein, a lower cost starting point can be assigned to tracks that are generated more recently. For example, if Track 2 216-1 is generated more recently than Track 1 218-1, state A from Track 2 216-1 can have a lower cost than state A from Track 1 218-1. In another example, state A from Track 1 218-1 can have an additional aging cost after another request. As such, state A from Track 2 has the lowest cost state. Since state A from Track 2 has a lower cost than state A from Track 1, Track 2 has a state with lowest cost and is the selected track after current request A 214-1.

After current request A 214-1, Track 2 can be utilized to generate the stateful simulation program. For example, the response associated with the request-response pair of state A can be utilized when the current request sequence includes a current request A 214-1.

Current request B 214-2 is the second current request in the request order. State B from Track 2 216-2 and state B from Track 1 218-2 are active upon current request B 214-2. The state B was spawned from all previously active states. These are starting points and state A. As there are more active states in each track, we compute the spawn cost from each active state and assign state B the lowest spawn cost computed. The calculated lowest cost state can be state B from Track 2 216-2. As described herein, an additional cost can be attributed for a transition of a number of states within the sequence order to match the current request order. The current request order at 214-2 is A, B. In Track 1 218-2 state A is in the first position that corresponds to current request A 214-1, but state E, state D, and state C may be transitioned in order to reach state B from state A, which can correspond to current request B 214-2. For each transition there can be an additional cost. There is no additional cost (e.g., no transitions) added to Track 2 216-2 since the sequence order is A, B. In this example, state B from Track 2 216-2 is the lowest cost state for current request B 214-2. Track 2 216-2 also has the lowest cost state and is selected as the track. Thus, the response associated with request-response pair of state B in Track 2 can be utilized when the current request sequence includes current request B 214-2.

At current request D 214-3, the current request sequence is A, B, D. The sequence order for Track 2 216-3 is A, B, C, D. Therefore, to produce the request sequence A, B, D from Track 2 216-3, there may have to be a transition of state C. With the transition of state C there may be an additional cost added. In Track 1 218-3, the sequence order is A, E, D, C, B, thus to produce the request order A, B, D, Track 1 218-3 may transition E and C to match the current request. The current request 214-3 results in additional transition cost to be added to spawned D states in both tracks. This is second time additional transition cost was added in Track 1, but first time for the Track 2. Thus, state D from Track 2 216-3 has the lowest cost. Accordingly, the response associated with state D from Track 2 216-3 can be utilized as the response to the current request D 214-3.

At current request C 214-4, the current request sequence is A, B, D, C. The sequence order for Track 2 216-4 is A, B, C, D, E and active states are Starting point, A, B, D. To spawn into the C state, we spawn from all active states and select the spawn with the lowest cost. Therefore, to produce the request sequence A, B, D, C from Track 2 216-4, there may have to be a reverse transition from state D to state C. A reverse transition can have an additional cost that is greater than a forward transition. For example, the cost of a forward transition can be 0.1 and the cost of a reverse transition can be 1.0. The sequence order for Track 1 218-4 is A, E, D, C, B and the active states are Starting point, A, D, B. To spawn into the C state, we spawn from all active states in Track 1 and select the spawn with the lowest cost. In this case, the transition of state E can allow state D and state C to be in the correct corresponding positions. Therefore, state C can be activated with only a single transition and no reverse transition. For this reason, state C from Track 1 218-4 has the lowest cost state, and as a result, Track 1 has the state with the lowest cost and is selected. Accordingly, the response associated with state C from Track 1 218-4 can be utilized as the response to the current request C 214-4.

At current request B 214-5, the current request sequence is A, B, C, B. The sequence order for Track 2 216-5 is A, B, C, D, E and active states are Starting point, A, B, C, D. We spawn from the active states to the B states and associate to B state a lowest cost from all the spawns performed. Therefore, to produce A, B, D, C, B from Track 2 216-5, there may have to be a transition of state C and a reverse transition to return to state C and a reverse transition to return to state B. This can result in a transition penalty and a reverse transition penalty. This can result in a total of two additional costs accumulated in the lowest cost of Track 2 216-5. The sequence order for Track 1 218-5 is A, E, D, C, B and active states are Starting point, A, D, C. We spawn from the active states to the B states in Track 1. Therefore, to produce A, B, D, C, B from Track 1 218-5 there can be a transition of state E. This can result in a transition penalty and a single additional cost. Thus, state B from Track 1 218-5 can be the lowest cost and can be the selected track. Accordingly, the response associated with state B from Track 1 218-5 can be utilized as the response to the current request B 214-5.

The current requests can continue for 214-N number of times. Wherein N represents any number greater than 0.

As described herein, an aging cost can be associated with each active state after each current request. The aging cost can increase the cost for a state that was utilized in an earlier current request and result in the state not being saved for a later current request. By saving a number of states for each current request an amount of total memory can be decreased compared to saving all states from all tracks.

As described herein, an active state can spawn a non-active or active state to an active state upon a current request. For example, the starting point 220, as an active state, can spawn state A in Track 2 216-1 to an active state upon current request A 214-1. A cost can be calculated from each active state attempting to spawn the non-active or active state that corresponds to a current request. For example, at current request C 214-4 a diagram of arrows 219-1, 219-2, . . . , 219-4 are shown to represent a spawning to the state C matching current request C 214-4 from a number of active states (e.g., starting point, A, D, B).

The diagram of arrows 219-1, 219-2, . . . , 219-4 can each represent a cost associated with the corresponding active state spawning into state C within Track 1 218-4. As described herein, the cost to spawn state C within Track 1 218-4 can include a previous cost and a transition cost. For example, arrow 219-1 can include a previous cost of 0.3. The previous cost can include an additional cost for being a less recent track at current request A 214-1 and an aging cost for current request B 214-2 and current request D 214-3. If the aging cost for each current request is 0.1, then the previous cost for the starting point of Track 1 218-3 at current request D 214-3 can be 0.3. Calculating the transition cost of arrow 219-1 can include an additional cost for a transition of state A, state E, and state D. The previous cost and the transition cost can result in a cost of 0.6 for arrow 219-1.

Arrow 219-2 can represent the active state A within Track 1 218-4 spawning the non-active state C within Track 1 218-4. The previous cost for the active state A within Track 1 218-4 can be 0.3. The cost of spawning state C to an active state by state A can include the previous cost and the transition cost. The transition cost can include an additional cost for a transition of state E and state D. If each transition results in an additional cost of 0.1, the cost of spawning state C to an active state by state A can have a cost of 0.5.

Arrow 219-3 can represent the active state D within Track 1 218-4 spawning the non-active state C within Track 1 218-4. The previous cost for the active state D within Track 1 218-4 can be 0.3. The cost of spawning state C to an active state by state D can include additional cost for a transition. In this example there is not a transition necessary to reach state C, and therefore there can be no additional cost added to the previous cost of state D. The cost of spawning state C from state D can be 0.3.

Arrow 219-4 can represent the active state B within Track 1 218-4 spawning the non-active state C within Track 1 218-4. The previous cost for the active state B can be 0.7. A transition cost can be added to the previous cost of state B to determine the cost of spawning state C from state B. In this example, state B can transition in a reverse direction to spawn state C. An additional cost can be added for a transition in a reverse direction.

An additional cost greater than the additional cost for a transition in a forward direction can be assigned for a transition in a reverse direction. For example, as described herein, an additional cost for a transition can include a cost of 0.1. In the same example, a transition in a reverse direction can have an additional cost of 1.0. In example of arrow 219-4, the cost of spawning state C from state B can be 1.7. This includes the previous cost of state B (0.7) with an additional cost for a transition in a reverse direction of 1.0.

A forward direction can include a direction away from starting point in a single direction of the sequence order. For example, Track 1 218-4 can have a sequence order and a forward direction of: the starting point 220, state A, state E, state D, state D, and state B.

FIG. 3 illustrates a diagram of an example computing system 332 that can be utilized for generating a stateful simulation program according to the present disclosure. The computing system 332 can include a computing device 312 that can utilize software, hardware, firmware, and/or logic to for generate a stateful simulation program.

The computing device 312 can be any combination of hardware and program instructions configured to generate a stateful simulation program. The hardware, for example can include one or more processing resources 348-1, 348-2, . . . , 348-N, computer readable medium (CRM) 340, etc. The program instructions (e.g., computer-readable instructions (CRI) 342) can include instructions stored on the CRM 340 and executable by the processing resources 348-1, 348-2, . . . , 348-N to implement a desired function (e.g., select a response that is associated with a state for a current request, etc.).

CRM 340 can be in communication with a number of processing resources of more or fewer than 348-1, 348-2, . . . , 348-N. The processing resources 348-1, 348-2, . . . , 348-N can be in communication with a tangible non-transitory CRM 340 storing a set of CRI 342 executable by one or more of the processing resources 348-1, 348-2, . . . , 348-N, as described herein. The CRI 342 can also be stored in remote memory managed by a server and represent an installation package that can be downloaded, installed, and executed. The computing device 312 can include memory resources 349, and the processing resources 348-1, 348-2, . . . , 348-N can be coupled to the memory resources 349.

Processing resources 348-1, 348-2, . . . , 348-N can execute CRI 342 that can be stored on an internal or external non-transitory CRM 340. The processing resources 348-1, 348-2, . . . , 348-N can execute CRI 342 to perform various functions, including the functions described in FIG. 1 and FIG. 2. For example, the processing resources 348-1, 348-2, . . . , 348-N can execute CRI 342 to implement the method of FIG. 1 and the process described in FIG. 2.

The CRI 342 can include a number of modules 352, 354, 356, 358, 360. The number of modules 352, 354, 356, 358, 360 can include CRI that when executed by the processing resources 348-1, 348-2, . . . , 348-N can perform a number of functions as described herein.

The recording module 352 can record a number of requests and a number of responses. The recording module 352 can record the number of requests and the number of responses as corresponding request-response pairs. As used herein, corresponding request-response pair can be defined as a request to an application and the resulting response of the application. The number of request-response pairs that are recorded can generate a number of tracks.

The arranging module 354 can arrange the number of request-response pairs in a sequence order as described herein. The arranging module 354 can determine the sequence order and designate a starting point for each of the number of tracks that are recorded.

The assigning module 356 can assign a state to each of the number of request-response pairs as described herein. After each current request is made and determined, the assigning module 356 can assign an active state to the number of request-response pairs and/or states that correspond to the current request.

The cost module 358 can calculate a cost for each state based on the number of current requests as described herein. The cost module 358 can re-calculate the cost for each of the number of states within each of the number of tracks after each of the number of current requests. The cost module can also determine the lowest cost state and the track with the lowest overall cost as described herein.

The generation module 360 can generate a stateful simulation response based on the lowest cost state as described herein. The generation module 360 can utilize the state cost calculated by the cost module 358.

A non-transitory CRM 340, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 340 can be integral, or communicatively coupled, to a computing device, in a wired and/or a wireless manner. For example, the non-transitory CRM 340 can be an internal memory, a portable memory, a portable disk, or a memory associated with another computing resource (e.g., enabling CRIs to be transferred and/or executed across a network such as the Internet).

The CRM 340 can be in communication with the processing resources 348-1, 348-2, . . . , 348-N via a communication path 344. The communication path 344 can be local or remote to a machine (e.g., a computer) associated with the processing resources 348-1, 348-2, . . . , 348-N. Examples of a local communication path 344 can include an electronic bus internal to a machine (e.g., a computer) where the CRM 340 is one of volatile, non-volatile, fixed, and/or removable storage medium in communication with the processing resources 348-1, 348-2, . . . , 348-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 344 can be such that the CRM 340 is remote from the processing resources e.g., 348-1, 348-2, . . . , 348-N, such as in a network connection between the CRM 340 and the processing resources (e.g., 348-1, 348-2, . . . , 348-N). That is, the communication path 344 can be a network connection. Examples of such a network connection can include a local area network (LAN), wide area network (WAN), personal area network (PAN), and the Internet, among others. In such examples, the CRM 340 can be associated with a first computing device and the processing resources 348-1, 348-2, . . . , 348-N can be associated with a second computing device (e.g., a Java® server, network simulation engine 214). For example, a processing resource 348-1, 348-2, . . . , 348-N can be in communication with a CRM 340, wherein the CRM 340 includes a set of instructions and wherein the processing resource 348-1, 348-2, . . . , 348-N is designed to carry out the set of instructions.

The processing resources 348-1, 348-2, . . . , 348-N coupled to the memory 342 can execute CRI 342 to record a number of request-response pairs utilizing a real user monitor. The processing resources 348-1, 348-2, . . . , 348-N coupled to the memory 342 can also execute CRI 342 to create a number of tracks comprising the number of request-response pairs, wherein the number of request/response pairs are in a sequence order. The processing resources 348-1, 348-2, . . . , 348-N coupled to the memory 342 can also execute CRI 342 to receive a number of current requests in a request order and compare the number of current requests in the request order to the number of request-response pairs in the sequence order. The processing resources 348-1, 348-2, . . . , 348-N coupled to the memory 342 can also execute CRI 342 to assign a cost to each of the number of request-response pairs based on a number of matches in a first direction between the number of current requests and the number of request-response pairs. The processing resources 348-1, 348-2, . . . , 348-N coupled to the memory 342 can also execute CRI 342 to select a state with a desired cost from the number of states. The processing resources 348-1, 348-2, . . . , 348-N coupled to the memory 342 can also execute CRI 342 to generate a stateful simulation program based on the selected state. Furthermore, the processing resources 348-1, 348-2, . . . , 348-N coupled to the memory 342 can execute CRI 342 to create a starting point to compare the number of current requests and the number of request-response pairs, wherein the starting point is assigned a cost of 0.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for generating a stateful simulation program, comprising:
utilizing a processor to execute instructions on a non-transitory computer readable medium for:
arranging a number of recorded request-response pairs in a sequence order to generate a number of tracks;
assigning a state to each of the number of request-response pairs;
calculating a cost for each state based on a number of current requests; and
generating the stateful simulation program based on a selected state with a desired cost.

2. The method of claim 1, wherein calculating a cost comprises determining a number of matches between the number of request-response pairs and the number of current requests.

3. The method of claim 1, wherein assigning a state comprises assigning a number of active states for each of the number of current requests.

4. The method of claim 3, wherein assigning a number of active states comprises assigning a lowest cost active state.

5. The method of claim 1, wherein calculating a cost for each state comprises adding an additional cost for each transition of a state within the sequence order.

6. The method of claim 1, further comprising assigning a starting point within the sequence order of the number of request-response pairs, wherein the starting point is assigned an active state.

7. A non-transitory computer-readable medium storing a set of instructions executable by a processor to cause a computer to:
receive a number of current requests;
compare the number of current requests to a number of tracks, wherein the number of tracks comprise a number request-response pairs in a sequence order;
assign a starting point for each of the number of tracks and a state for each of the number of request-response pairs; and
determine a cost for each state and select a state with a desired cost and create a stateful simulation program based on an associated response with the selected state.

8. The medium of claim 7, further comprising instructions to assign an active state to the number of request-response pairs that match the number of current requests.

9. The medium of claim 7, wherein the a number of states with a desired cost are saved for each of the number of current requests.

10. The medium of claim 9, wherein the number of states with a desired cost can be altered.

11. The medium of claim 7, wherein the desired cost is the lowest cost for the number of states within a track.

12. A system for generating a stateful simulation program, the system comprising:
a processing resource in communication with a non-transitory computer readable medium, wherein the non-transitory computer readable medium includes a set of instructions and wherein the processing resource executes the set of instructions to:
record a number of request-response pairs utilizing a real user monitor;
create a number of tracks comprising the number of request-response pairs, wherein the number of request/response pairs are in a sequence order;
receive a number of current requests in a request order and compare the number of current requests in the request order to the number of request-response pairs in the sequence order;
assign a cost to each of the number of request-response pairs based on a number of matches in a first direction between the number of current requests and the number of request-response pairs;
select a state with a desired cost from the number of tracks; and
generate a stateful simulation program based on the response associated with the selected state.

13. The system of claim 12, wherein the cost is based on a number of transitions from an active state to a non-active state that corresponds to a current request from the number of current requests.

14. The system of claim 13, wherein an additional cost is assigned to a state for a transition.

15. The system of claim 12, further comprising instructions to create a starting point to compare the number of current requests and the number of request-response pairs, wherein the starting point is assigned a cost less than infinity.
